(19) United States
(12) Patent Application Publication
(10) Pub. No.: US 2020/0356914 A1
(43) Pub. Date: Nov. 12, 2020

(54) DIGITAL ENTERPRISE SOLUTION FOR OILFIELD OPERATION RESOURCE MANAGEMENT, PLANNING, ANALYTICS, COMMUNICATION, AUTOMATION, CONTROL AND DECISION-MAKING BUSINESS SYSTEM AND METHODS OF USE

(71) Applicant: Ramana Palisetti, Sugarland, TX (US)

(72) Inventor: Ramana Palisetti, Sugarland, TX (US)

(21) Appl. No.: 16/406,924

(22) Filed: May 8, 2019

(51) Int. Cl. G06Q 10/06; G06Q 30/02; G06Q 50/30

(52) U.S. Cl. CPC G06Q 10/063; G06Q 50/30; G06Q 30/0201

(57) ABSTRACT

A petroleum oilfield enterprise operations management system for collecting, presenting and evaluating raw and processed data and information related to the extraction and distribution of hydrocarbon products. The system allows for multiple sources of information to the collected, parsed, manipulated and presented to those making decisions related a process or business.

### BACKGROUND

### 1. Field of the Invention

The present invention relates to management and control systems, and more specifically, to a petroleum oilfield enterprise operations management system for collecting, presenting and evaluating raw and processed data and information related to the extraction and distribution of hydrocarbon products.

The term “data” referred to herein shall mean raw data, real-time data, delayed-time data, processed data, analyzed data, synthesized data, data converted to information, communications between users or data sources and many other forms or transformations.

### 2. Description of Related Art

Management and control systems are well known in the art and are effective means to allow for the efficient execution or influence of complex tasks, organizations or processes. For example, spreadsheets, charts, reports and other conventional data communication tools are prepared either manually or by computing devices and presented to those with the responsibility of making decisions regarding the success of the associated project. With the aid of the communication tools changes are made to the project whereupon the project is monitored, and the same communication tools are updated and presented anew to the decision maker.

One of the problems commonly associated with arrangement 101 is its limited efficiency. For example, the time delay involved in creating or generating the communication tools is time lost to the project and its performance.

Additionally, while many communication tools are used to manage or control a project they may not be collected and presented as a whole but utilized on a limited basis by individual decision makers.

Accordingly, although great strides have been made in other industries in the area of enterprise resource management and control systems independent of each other, many shortcomings remain specifically in petroleum operations resource management, planning, analytics, automation and control systems and in the integration of enterprise solutions with automation and control systems.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a digital enterprise solution for oilfield operation resource management, planning, analytics, communication, automation, control and decision-making business system in accordance with a preferred embodiment of the present application;

FIG. 2 is a diagram of the domain and data analytics engine of FIG. 1; and

FIG. 3 is a flowchart of the preferred method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional management and control systems. Specifically, the invention of the present application allows for the collection, processing and presentation of data and information related to the extraction of oil or similar resources. In addition, the invention presents a complete view of the project to allow for better control or management thereof. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

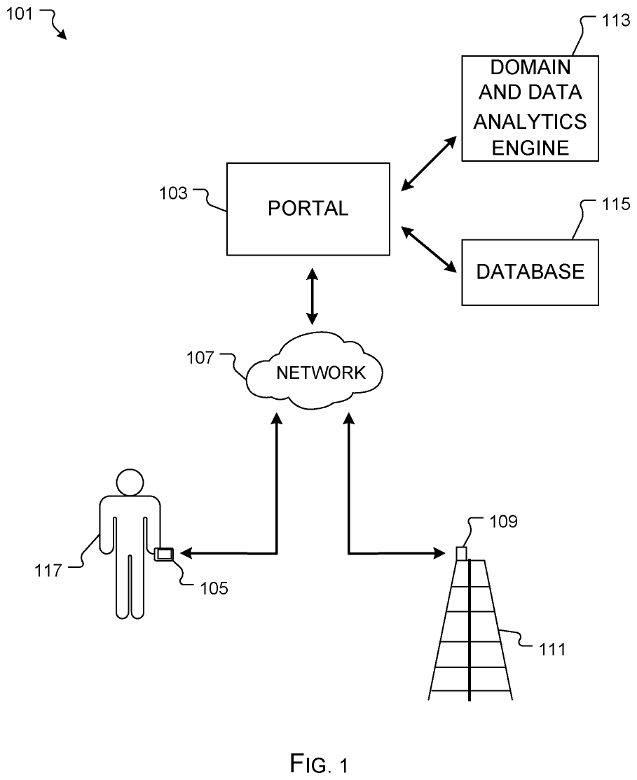

Referring now to the drawings wherein like reference characters identify corresponding or similar elements throughout the several views, FIG. 1 depicts a diagram of a digital enterprise solution for oilfield operation resource management, planning, analytics, communication, automation, control and decision-making business system in accordance with a preferred embodiment of the present application. It will be appreciated that system 101 overcomes one or more of the above-listed problems commonly associated with conventional management and control systems.

In the contemplated embodiment, system 101 includes a portal 103 in electronic communication with a computing device 105 via a network 107. The portal 103 also in electronic communication with a data recorder 109 attached to an asset 111 such as a petroleum well. The portal 103 communicates with a domain and data analytics engine 113 and a database 115. Communication tools include but not limited to mobile devices, real-time data acquisition and transmission devices with various modes of information exchange.

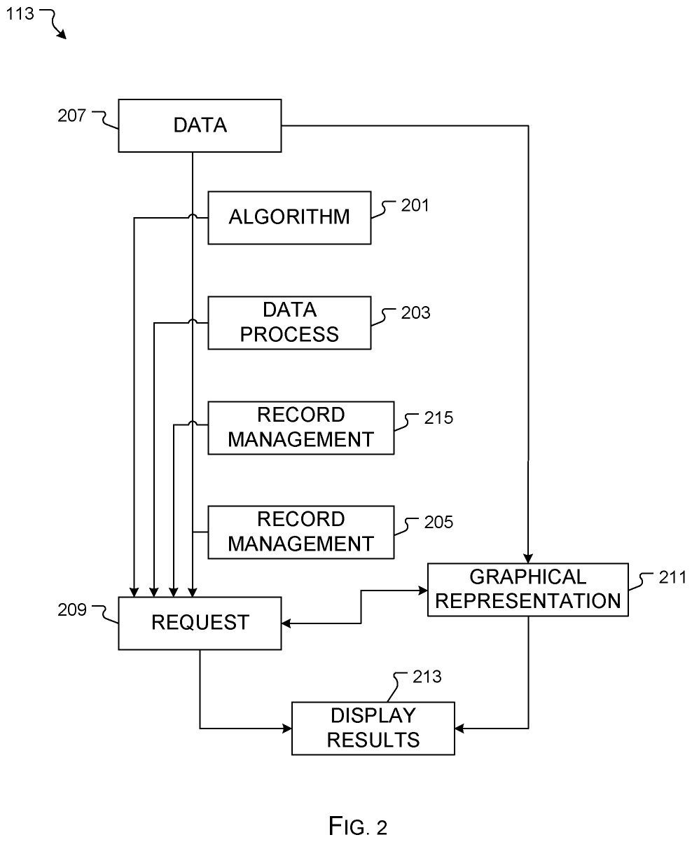

Referring now to FIG. 2 the domain and data analytics engine 113 is depicted. Domain and data analytics engine 113 includes algorithms 201, data processes module 203, a record management module 215 and an extrapolation module 205 that the data 207 pass through to respond to a request 209. The data 207 also passes through a graphical representation module 211 either before or after interpretation for the request 209. The domain and data analytics engine 113 also included a display results sequence 213 where the data 207 is presented for a user 117. It is also contemplated that the system 101 could utilize artificial intelligence, machine learning, big data analytics or other such techniques or technologies.

It is contemplated that the system 101 could communicate with or connect to other enterprise systems, business systems or applications so that the portal 103 is capable of providing data related to the production or health of a petroleum production asset.

It is contemplated that the portal 103 accepts data from one or many data recorders 109 to capture information relative to the extraction or production of petroleum. It is further contemplated that the domain and data analytics engine 113 is configured to interrogate, alter compound or otherwise manipulate the data 207 captured by system 101.

In use, a user 117 accesses the portal 103 via the computing device 105 and network 107. The portal 103 collects data 207 from the data recorder 109 and passes the data 207 to the domain and data analytics engine 113 and database 115. The domain and data analytics engine 113 manipulates the data 207 to provide the user 117 with real-time or as close to real-time as possible, information critical to controlling the extraction of petroleum.

It should be appreciated that one of the unique features believed characteristic of the present application is that domain and data analytics engine 113 acts as a library of information relative to a petroleum production project or process and that the information is there prepared for presentation via the portal 103. It will further be appreciated that the portal 103 provides a complete view of the data 207 available to improve the decision-making process.

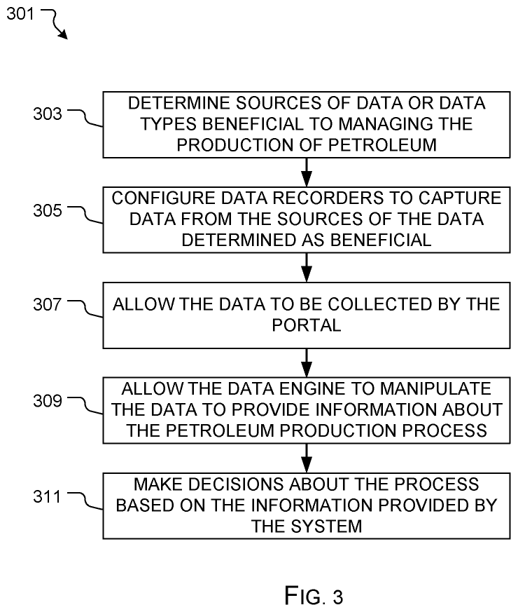

Referring now to FIG. 3 the preferred method of use of the system 101 is depicted. Method 301 includes determining sources of data or data types beneficial to managing the production of petroleum 303, configuring data recorders to capture data from the sources of the data determined as beneficial 305, allowing the data to be collected by the portal 307, allowing the data engine to manipulate the data to provide information about the petroleum production process 309 and making decisions about the process based on the information provided by the system 311.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. (canceled)

2. (canceled)

3. The method of obtaining and presenting information, comprising:
securing a data recorder to a well and/or any oilfield asset;
determining sources of data or data types beneficial to managing the production of petroleum from the data recorder secured to the well and/or and oilfield asset;
configuring the data recorder to capture data from the sources of the data determined as beneficial;
providing a portal in electronic communication with a computing device via a network;
allowing the data to be collected by the portal;
allowing the data engine to manipulate the data to provide information about the petroleum production process; and
making decisions about the process based on the information provided by the system.
